(19) United States
(12) Patent Application Publication
(10) Pub. No.: US 2026/0024226 A1
(43) Pub. Date: Jan. 22, 2026

(54) INFORMATION PROCESSING DEVICE, INFORMATION PROCESSING METHOD, AND COMPUTER-READABLE MEDIUM

(71) Applicant: Socionext Inc., Kanagawa (JP)

(72) Inventors: Yasuhiro OUCHI, Yokohama (JP); Kazuyuki OHHASHI, Yokohama (JP)

(21) Appl. No.: 19/106,948

(22) PCT Filed: Sep. 14, 2022
(86) PCT No.: PCT/JP2022/034380

§ 371 Date: Feb. 26, 2025

(51) Int. Cl. G06T 7/73; G01C 21/30; G06T 3/08

(52) U.S. Cl. CPC G06T 7/73; G01C 21/30; G06T 3/08; G06T 2207/30252

(57) ABSTRACT

In one aspect, an information processing device includes a map information generation unit. The map information generation unit initializes a range related to detection by a sensor mounted on a moving body in map information including first peripheral position information that is information of a position of an object located in a periphery of the moving body, and adds second peripheral position information acquired from the sensor to the range.

### TECHNICAL FIELD

The present invention relates to an information processing device, an information processing method, and an information processing program.

### BACKGROUND ART

There is a technology of acquiring positional information such as a positional relationship between a moving body and an object in a periphery of the moving body by using a sensor such as a sonar. In addition, there is a technology of acquiring (estimating) position information indicating a position of a moving body and a position of an object around the moving body by performing visual simultaneous localization and mapping (SLAM) processing by using an acquired image of a periphery of the moving body. In addition, there is a technology of deforming a shape of a projection surface to generate a bird's-eye view image of a periphery of a moving body by using acquired position information (map information) such as a position of the moving body and a position of an object in the periphery of the moving body.

### CITATION LIST

### Patent Literature

Patent Literature 1: WO 2021/111531
Patent Literature 2: US 2021/0140934 A
Patent Literature 3: US 2021/0323539 A

### SUMMARY OF INVENTION

### Problem to be Solved by the Invention

However, with respect to acquisition of map

information, for example, in a case where a moving object (such as a pedestrian) in a periphery of a moving body is detected by a sonar, position information of the moving object is accumulated in accordance with movement of the moving object. At this time, the position information is accumulated in such a manner that there is a three- dimensional object such as a wall along a trace of the moving object. When the position information is accumulated in such a manner that there is the three- dimensional object, a shape of a projection surface may not be appropriately deformed.

In one aspect, an object of the present invention is to provide an information processing device, an information processing method, and an information processing program capable of generating accurate map information.

### Means for Solving Problem

An information processing device according to the present invention includes, in an aspect, a map information generation unit. The map information generation unit initializes a range related to detection by a sensor mounted on a moving body in map information including first peripheral position information that is information of a position of an object located in a periphery of the moving body, and adds second peripheral position information acquired from the sensor to the range.

### Effect of the Invention

According to one aspect of an information processing device disclosed in the present application, accurate map information can be generated. As a result, according to the one aspect of the information processing device disclosed in the present application, for example, a shape of a projection surface can be appropriately deformed by utilization of accurate map information.

### BRIEF DESCRIPTION OF DRAWINGS

FIG. 1 is a view illustrating an example of an overall configuration of an information processing system according to an embodiment;

FIG. 2 is a view illustrating an example of a hardware configuration of an information processing device according to the embodiment;

FIG. 3 is a view illustrating an example of a functional configuration of the information processing device according to the embodiment;

FIG. 4 is a flowchart illustrating an example of a procedure of map information generation processing according to the embodiment;

FIG. 5 is a schematic diagram illustrating an example of map information according to the embodiment;

FIG. 6 is a view illustrating an example of the map information of a case where a moving body travels in a traveling direction from a position thereof illustrated in FIG. 5 according to the embodiment;

FIG. 7 is a view illustrating an example of the map information of a case where a moving body travels in the traveling direction from a position thereof illustrated in FIG. 6 according to the embodiment;

FIG. 8 is a view illustrating an example of the map information of a case where a moving body is parked backward between two vehicles according to the embodiment;

FIG. 9 is a view illustrating an example of the map information in backward parking different from that in FIG. 8 according to the embodiment;

FIG. 10 is a view illustrating an example of the map information of a state in which the moving body moves in a backward direction from a position of the moving body in FIG. 9 according to the embodiment;

FIG. 11 is a schematic diagram illustrating an example of a reference projection surface according to the embodiment;

FIG. 12 is a schematic diagram illustrating an example of a projection shape according to the embodiment;

FIG. 13 is an explanatory diagram of an asymptotic curve according to the embodiment;

FIG. 14 is a schematic diagram illustrating an example of a configuration of a determination unit according to the embodiment;

FIG. 15 is a schematic diagram illustrating an example of the map information according to the embodiment; and

FIG. 16 is a flowchart illustrating an example of a procedure of image processing executed by the information processing device according to the embodiment.

### DESCRIPTION OF EMBODIMENTS

Hereinafter, embodiments of an information processing device, an information processing method, and an information processing program disclosed in the present application will be described in detail with reference to the accompanying drawings. Note that the following embodiments do not limit the disclosed technology. In addition, the embodiments can be appropriately combined within a range in which processing contents do not contradict each other.

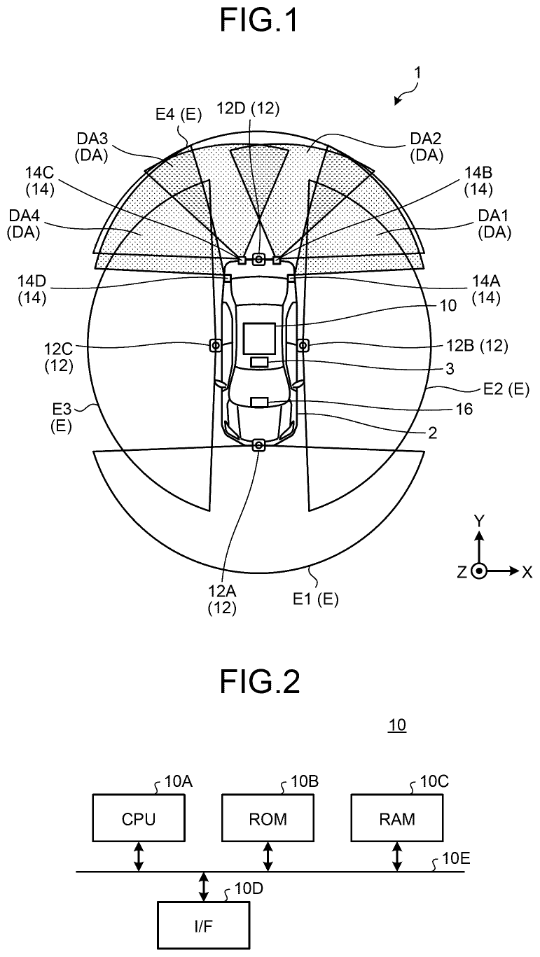

FIG. 1 is a view illustrating an example of an overall configuration of an information processing system 1 of the present embodiment. The information processing system 1 includes an information processing device 10, a photographing unit 12, a detection unit 14, and a display unit 16. The information processing device 10, the photographing unit 12, the detection unit 14, and the display unit 16 are connected in such a manner as to be able to exchange data or signals.

In the present embodiment, a form in which the information processing device 10, the photographing unit 12, the detection unit 14, and the display unit 16 are mounted on a moving body 2 will be described as an example.

The moving body 2 is a movable object. The moving body 2 is, for example, a vehicle, a flying object (such as a manned airplane, an unmanned airplane (such as an unmanned aerial vehicle (UAV)), or a drone), a robot, a ship, or the like. In addition, the moving body 2 is, for example, a moving body that travels through driving operation by a person or a moving body that can automatically travel (autonomously travel) without driving operation by a person. In the present embodiment, a case where the moving body 2 is a vehicle will be described as an example. Examples of the vehicle include a two-wheeled automobile, a three-wheeled automobile, and a four-wheeled automobile. In the present embodiment, a case where the vehicle is the four-wheeled automobile will be described as an example.

Note that all of the information processing device 10, the photographing unit 12, the detection unit 14, and the display unit 16 are not necessarily mounted on the moving body 2. The information processing device 10 may be mounted on a stationary object. The stationary object is, for example, an object fixed to the ground. Specifically, the stationary object is an immovable object or an object in a stationary state with respect to the ground. Furthermore, the information processing device 10 may be mounted on a cloud server that executes processing on a cloud.

The photographing unit 12 photographs a periphery of the moving body 2 and acquires photographed image data. Hereinafter, the photographed image data will be simply referred to as a photographed image. The photographing unit 12 is, for example, a digital camera capable of photographing a moving image. Note that photographing refers to converting an image of a subject which image is formed by an optical system such as a lens into an electric signal. The photographing unit 12 outputs the photographed image to the information processing device 10.

Furthermore, in the present embodiment, a description will be given on the assumption that the photographing unit 12 is a monocular fisheye camera (for example, a viewing angle is 195 degrees).

In the present embodiment, a form in which four photographing units 12 that are a front photographing unit 12A, a left photographing unit 12B, a right photographing unit 12 C, and a rear photographing unit 12D are mounted on the moving body 2 will be described as an example. The plurality of photographing units 12 (front photographing unit 12A, left photographing unit 12B, right photographing unit 12C, and rear photographing unit 12D) respectively photographs subjects in photographing regions E in different directions (front photographing region E1, left photographing region E2, right photographing region E3, and rear photographing region E4) and acquires photographed images. That is, it is assumed that the plurality of photographing units 12 has different image photographing directions. In addition, it is assumed that the photographing directions of the plurality of photographing units 12 are adjusted in advance in such a manner that at least a part of the photographing regions E overlaps between the adjacent photographing units 12. In FIG. 1, although being illustrated in a size illustrated in FIG. 1 for convenience of description, the photographing regions E actually include a region further away from the moving body 2.

The four front photographing unit 12A, left photographing unit 12B, right photographing unit 12C, and rear photographing unit 12D are examples, and the number of the photographing units 12 is not limited. For example, in a case where the moving body 2 has a vertically long shape as a bus or a truck, it is also possible to arrange the photographing units 12 one each in a front, a rear, a front of a right side surface, a rear of the right side surface, a front of a left side surface, and a rear of the left side surface of the moving body 2, and to use the six photographing units 12 in total. That is, the number and arrangement positions of the photographing units 12 can be arbitrarily set according to a size and a shape of the moving body 2.

The detection unit 14 detects position information of each of a plurality of detection points in the periphery of the moving body 2. In other words, the detection unit 14 detects the position information of each of the detection points in a detection region DA. The detection points indicate points that are in a real space and individually observed by the detection unit 14. The detection point corresponds to, for example, a position of a three-dimensional object in the periphery of the moving body 2.

The position information of the detection point is information indicating the position of the detection point in the real space (three-dimensional space). The position information of the detection point is, for example, information indicating a distance from the detection unit 14 (that is, the position of the moving body 2) to the detection point and a direction of the detection point with reference to the detection unit 14. These distance and direction can be expressed by, for example, position coordinates indicating a relative position of the detection point with reference to the detection unit 14, position coordinates indicating an absolute position of the detection point, a vector, or the like.

The detection unit 14 is, for example, a three-dimensional (3D) scanner, a two dimensional (2D) scanner, a distance sensor (millimeter wave radar or laser sensor), a sonar sensor that detects an object by sound waves, an ultrasonic sensor, or the like. The laser sensor is, for example, a three-dimensional laser imaging detection and ranging (LiDAR) sensor. Furthermore, the detection unit 14 may be a device using a technology such as a motion stereo method of measuring a distance from an image photographed by a stereo camera or a monocular camera, such as a structure from motion (SfM) technology. Furthermore, the plurality of photographing units 12 may be used as the detection unit 14. Furthermore, one of the plurality of photographing units 12 may be used as the detection unit 14.

Furthermore, although description will be made on the assumption that the detection unit 14 as the sensor is the sonar sensor in the present embodiment, this is not a limitation, and various known sensors for distance measurement can be used as the detection unit 14. Note that the detection unit 14 as the sensor may be the distance sensor mounted on a rear of the moving body 2. The rear of the moving body 2 corresponds to, for example, a direction opposite to a reference direction in the moving body 2. In a case where the moving body 2 is the vehicle, the reference direction corresponds to a direction on a front of a driver (forward direction). Furthermore, the distance sensor as the detection unit 14 may be further arranged on a side of the moving body 2. In addition, the plurality of sensors is not limited to the above description, and can be mounted at any places in the moving body 2 as long as the periphery of the moving body 2 can be detected. In a case where the plurality of sensors is sensors capable of measuring only a distance, the detection unit 14 may calculate position information of a planar object by triangulation using a plurality of pieces of distance information output from the plurality of sensors.

In the present embodiment, a plurality of the detection units 14 is mounted on the moving body 2. At this time, as illustrated in FIG. 1, for example, the plurality of sensors (14A, 14B, 14C, and 14D) is arranged in an array on an exterior of the moving body 2. In the present embodiment, a form in which the four detection units 14 that are a left rear detection unit 14A, a rear left detection unit 14B, a rear right detection unit 14C, and a right rear detection unit 14D of the moving body 2 are mounted will be described as an example.

The plurality of detection units 14 (left rear detection unit 14A, rear left detection unit 14B, rear right detection unit 14C, and right rear detection unit 14D) detect pieces of the position information of the plurality of detection points included in detection regions DA in different directions (left rear detection region DA1, rear left detection region DA2, rear right detection region DA3, and right rear detection region DA4). That is, it is assumed that the plurality of detection units 14 have different ranges related to object detection (hereinafter, referred to as detection range). In addition, it is assumed that the detection directions of the plurality of detection units 14 are adjusted in advance in such a manner that at least a part of the detection regions DA overlaps between the adjacent detection units 14. In addition, in FIG. 1, although being illustrated in a size illustrated in FIG. 1 for convenience of description, the detection regions DA may actually include a region further away from the moving body 2. In addition, the detection ranges illustrated in FIG. 1 are ranges included in the plurality of detection regions (DA1 to DA4) and are assumed to have fan shapes for convenience of description.

In addition, the four left rear detection unit 14A, rear left detection unit 14B, rear right detection unit 14C, and right rear detection unit 14D are examples, and the number of detection units 14 is not limited. For example, in a case where the moving body 2 has a vertically long shape as a bus or a truck, the detection unit 14 may be further arranged in each of the front of the moving body 2, the front of the right side surface, and the front of the left side surface, and the seven detection units 14 may be arranged in total. That is, the number and arrangement positions of the detection units 14 can be arbitrarily set according to the size and the shape of the moving body 2.

The display unit 16 displays various kinds of information. The display unit 16 is, for example, a liquid crystal display (LCD), an organic electro-luminescence (EL) display, or the like.

In the present embodiment, the information processing device 10 is communicably connected to an electronic control unit (ECU) 3 mounted on the moving body 2. The ECU 3 is a unit that performs electronic control of the moving body 2. In the present embodiment, it is assumed that the information processing device 10 can receive controller area network (CAN) data such as a speed and a moving direction of the moving body 2 from the ECU 3.

Next, a hardware configuration of the information processing device 10 will be described.

FIG. 2 is a view illustrating an example of a hardware configuration of the information processing device 10.

The information processing device 10 includes a central processing unit (CPU) 10A, a read only memory (ROM) 10B, a random access memory (RAM) 10C, and an interface (I/F) 10D, and is, for example, a computer. The CPU 10A, the ROM 10B, the RAM 10C, and the I/F 10D are mutually connected by a bus 10E, and have a hardware configuration using a normal computer.

The CPU 10A is an arithmetic device that controls the information processing device 10. The CPU 10A corresponds to an example of a hardware processor. The ROM 10B stores a program and the like that realize various kinds of processing by the CPU 10A. The RAM 10C stores data necessary for the various kinds of processing by the CPU 10A. The I/F 10D is an interface that is connected to the photographing units 12, the detection units 14, the display unit 16, the ECU 3, and the like and is to transmit and receive data.

A program for executing the information processing executed by the information processing device 10 of the present embodiment is provided by being incorporated in the ROM 10B or the like in advance. Note that the program executed by the information processing device 10 of the present embodiment may be provided by being recorded in a recording medium as a file in a format that can be installed or executed in the information processing device 10. The recording medium is a computer-readable medium. The recording medium is a compact disc (CD)-ROM, a flexible disk (FD), a CD-Recordable (R), a digital versatile disk (DVD), a universal serial bus (USB) memory, a secure digital (SD) card, or the like.

Next, a functional configuration of the information processing device 10 according to the present embodiment will be described. The information processing device 10 initializes a range (detection range) DA related to detection by the sensors (detection units 14) mounted on the moving body 2 in map information including first peripheral position information that is information of a position of an object located in the periphery of the moving body, and adds position information of detection points (second peripheral position information) acquired from the sensors to the detection range DA. The information processing device 10 connects a plurality of spatially adjacent photographed images, and generates and displays a composite image (bird's-eye view image) that looks down the periphery of the moving body 2.

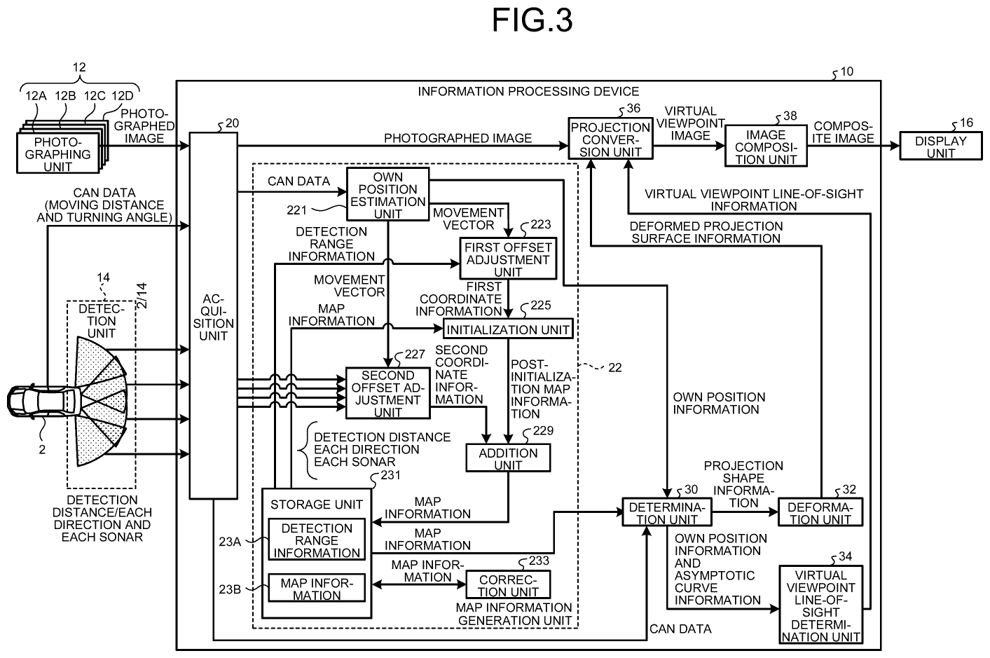

FIG. 3 is a view illustrating an example of a functional configuration of the information processing device 10. Note that in order to clarify an input/output relationship of data, the photographing units 12, the detection units 14, the display unit 16, and the like are illustrated in FIG. 3 in addition to the information processing device 10.

The information processing device 10 includes an acquisition unit 20, a map information generation unit 22, a determination unit 30, a deformation unit 32, a virtual viewpoint line-of-sight determination unit 34, a projection conversion unit 36, and an image composition unit 38.

A part or all of the plurality of units may be realized, for example, by execution of a program by a processing device such as the CPU 10A, that is, by software. In addition, a part or all of the plurality of units may be realized by hardware such as an integrated circuit (IC), or may be realized by software and hardware in combination.

The acquisition unit 20 acquires photographed images from the photographing units 12. For example, the acquisition unit 20 acquires the photographed image from each of the front photographing unit 12A, the left photographing unit 12B, the right photographing unit 12C, and the rear photographing unit 12D. Every time the photographed image is acquired, the acquisition unit 20 outputs the acquired photographed image to the projection conversion unit 36.

The acquisition unit 20 acquires CAN data such as a moving distance and a turning angle from the moving body 2, and the acquisition unit 20 outputs the acquired CAN data to the map information generation unit 22 every time the CAN data is acquired. Specifically, the acquisition unit 20 outputs the acquired CAN data to an own position estimation unit 221.

The acquisition unit 20 acquires the position information of the detection points from the detection units 14. For example, the acquisition unit 20 acquires the position information of the detection point (second peripheral position information) from each of the left rear detection unit 14A, the rear left detection unit 14B, the rear right detection unit 14C, and the right rear detection unit 14D. The second peripheral position information corresponds to position information of an object located within a detection range in the periphery of the moving body 2. The acquisition unit 20 outputs the acquired position information to the map information generation unit 22 every time the position information of each of the plurality of detection points is acquired. Specifically, the acquisition unit 20 outputs the acquired position information to a second offset adjustment unit 227.

The map information generation unit 22 includes the own position estimation unit 221, a first offset adjustment unit 223, an initialization unit 225, the second offset adjustment unit 227, an addition unit 229, a storage unit 231, and a correction unit 233. Note that the correction unit 233 may be omitted as a modification example of the present embodiment. The map information generation unit 22 initializes a range related to detection by the sensors mounted on the moving body 2 in the map information including the first peripheral position information that is the information of the position of the object located in the periphery of the moving body, and adds the second peripheral position information acquired from the sensors to the range. Hereinafter, each component in the map information generation unit 22 will be described.

The own position estimation unit 221 estimates a position of the moving body 2 in a global coordinate system of the map information by, for example, odometry based on the CAN data. The odometry is, for example, a method of acquiring a movement amount of each wheel by calculation with respect to the CAN data such as a rotation angle of the wheel and a rotation angle of a steering wheel in the moving body 2, and estimating a position of the moving body 2 (own position information) from the cumulative calculation. For example, the own position estimation unit 221 estimates a movement vector (also referred to as relative movement amount information) of the moving body 2 on the basis of the position of the moving body 2 at an acquisition interval of the position information (that is, a time interval related to acquisition of temporally adjacent position information) by odometry based on the CAN data.

Note that in a case where LiDAR is used as the sensors in the detection units 14, the own position estimation unit 221 may estimate the position of the moving body 2 by LiDAR SLAM. Furthermore, in a case where a depth camera such as a time-of-flight (ToF) sensor, or the like is used as the sensors in the detection units 14, the own position estimation unit 221 may estimate the position of the moving body 2 by, for example, Depth SLAM.

The first offset adjustment unit 223 reads detection range information 23A related to the detection units 14 from the storage unit 231. The detection range information 23A is, for example, information indicating a range in which the detection units 14 detect a three-dimensional object (detection range). The detection range information 23A is set in advance by an inspection or the like based on performance (specifications: horizontal angle, maximum measurement distance, or the like) of various sensors used as the detection units 14, an attachment angle of the detection units 14 to the moving body 2, and the like, and is stored in the storage unit 231. Note that the detection range may be an entire region in which the object can be detected by the detection units 14, or may be a partial region close to the moving body 2 in the object detection range of the detection units 14. Furthermore, the detection range information 23A may be appropriately adjusted on the basis of, for example, speed information of the moving body 2 which speed information is based on the CAN data.

The first offset adjustment unit 223 adjusts an offset of the detection range of the detection points by the detection units 14 in the global coordinate system on the basis of the detection range information 23A related to the detection units 14 and the movement vector. The offset of the detection range of the detection units 14 is, for example, a deviation of the detection range with respect to an origin of the global coordinate system and a direction of the detection range. The first offset adjustment unit 223 outputs an adjusted first offset to the initialization unit 225 as first coordinate information.

The initialization unit 225 reads map information 23B from the storage unit 231. The map information 23B is, for example, information geographically indicating a peripheral condition of the moving body 2. The map information 23B is information in which a point cloud that is the position information of the detection points is registered in a three-dimensional coordinate space (global coordinate system) with a predetermined position in a real space as an origin (reference position). Note that own position information of the moving body 2 may be registered in the map information 23B. The information of the detection points (point cloud) registered in the map information 23B corresponds to the first peripheral position information. That is, the first peripheral position information is information of a position of an object located in the periphery of the moving body 2. Note that the first peripheral position information (and the second peripheral position information) may be acquired from, for example, the detection unit 14 realized by the distance sensor mounted on the rear of the moving body 2.

The initialization unit 225 specifies the detection range of the detection units 14 in the map information 23B on the basis of the map information 23B and the first coordinate information. An update range to be initialized by the initialization unit 225 corresponds to the detection range of the detection units 14 in the map information 23B with reference to the position of the moving body 2 (own position information). The initialization unit 225 initializes (resets) the update range in the map information 23B. For example, as initialization in the update range, the initialization unit 225 deletes peripheral position information included in the update range in the first peripheral position information from the map information 23B. At this time, since deleting the information included in the update range, the initialization unit 225 may be referred to as a deletion unit. Note that the initialization unit 225 may fill data in the update range with 0 as the initialization in the update range (zero padding, zero filling, and zero reset). In addition, the initialization unit 225 may determine and delete peripheral position information to be deleted as initialization (peripheral position information to be deleted) on the basis of the information of the detection range (detection range information 23A) and the information of the relative movement amount (movement vector) of the moving body 2 with respect to the origin in the map information 23B (relative movement amount information). The initialization unit 225 outputs the initialized map information (hereinafter, referred to as post-initialization map information) to the addition unit 229.

The second offset adjustment unit 227 adjusts the offset of the position of the detection point in the global coordinate system on the basis of the position information of the detection point (such as a detection distance of each sonar in each direction, and the like) and the movement vector. The offset of the position of the detection point is, for example, a position deviation of the detection point with respect to the origin of the global coordinate system and a direction of the detection point. The second offset adjustment unit 227 outputs the adjusted offset (second offset) to the addition unit 229 as second coordinate information.

The addition unit 229 specifies the detection range of the detection units 14 in the post-initialization map information on the basis of the post-initialization map information and the second coordinate information. Note that in a case where the moving body 2 is stopped, the detection range specified by the initialization unit 225 is applied to the post-initialization map information, and specification of the detection range by the addition unit 229 may be omitted. The addition unit 229 adds the second peripheral position information acquired by the sensors (detection units 14) to the detection range in the map information 23B. That is, the addition unit 229 registers the second peripheral position information in the detection range in the post-initialization map information. As a result, the map information 23B is updated. Note that the addition unit 229 may update the own position of the moving body 2 in the post-initialization map information on the basis of the movement vector output from the own position estimation unit 221. The addition unit 229 stores the updated map information in the storage unit 231 as new map information.

As a result, along with the acquisition of the second peripheral position information from the detection units 14 mounted on the moving body 2, new second peripheral position information is sequentially added to the map information 23B. For example, in a case where the moving body 2 is moving, the map information 23B is sequentially updated along with the movement of the moving body 2.

The storage unit 231 stores various kinds of data. A storage unit 26 is, for example, a semiconductor memory element such as a RAM or a flash memory, a hard disk, an optical disk, or the like. Note that the storage unit 231 may be a storage device provided outside the information processing device 10. Furthermore, the storage unit 231 may be a storage medium. Specifically, the storage medium may store or temporarily store a program or various kinds of information downloaded via a local area network (LAN), the Internet, or the like.

The correction unit 233 corrects the position information of each of the plurality of detection points registered in the map information 23B and the own position information of the moving body 2. The correction unit 233 corrects the position information registered in the map information 23B and the own position information by using the position information of each of the corresponding detection points P acquired at acquisition time after acquisition time of the detection points.

For example, the correction unit 233 corrects the position information of the detection points (first peripheral position information) registered in the map information 23B by using the position information of the corresponding detection points detected again by the detection units 14 (second peripheral position information). At this time, the correction unit 233 may correct the first peripheral position information and the own position information by further using various parameters registered in the map information 23B and used for calculation of the position information of each of the detection points P. By this correction processing, the correction unit 233 corrects an error in the first peripheral position information of the detection points registered in the map information 23B. The correction unit 233 may correct the first peripheral position information of the detection points P registered in the map information 23B by using, for example, a least squares method or the like. A cumulative error of the first peripheral position information of the detection points P is corrected by the correction processing by the correction unit 233. Note that the information processing device 10 may have a configuration not including the correction unit 233.

Hereinafter, as an example, a case where processing of generating the map information 23B (hereinafter, referred to as map information generation processing) is executed at predetermined time such as a parking scene of the moving body 2 is assumed. For example, when determining that the behavior of the moving body 2 becomes the behavior indicating the parking scene, the information processing device 10 determines that the predetermined time is reached. The behavior indicating the parking scene by a backward movement is, for example, a case where the speed of the moving body 2 becomes equal to or less than a predetermined speed, a case where a gear of the moving body 2 is set in a back gear, a case where a signal indicating a start of parking is received by an operation instruction by a user, or the like. Note that the predetermined time is not limited to the parking scene.

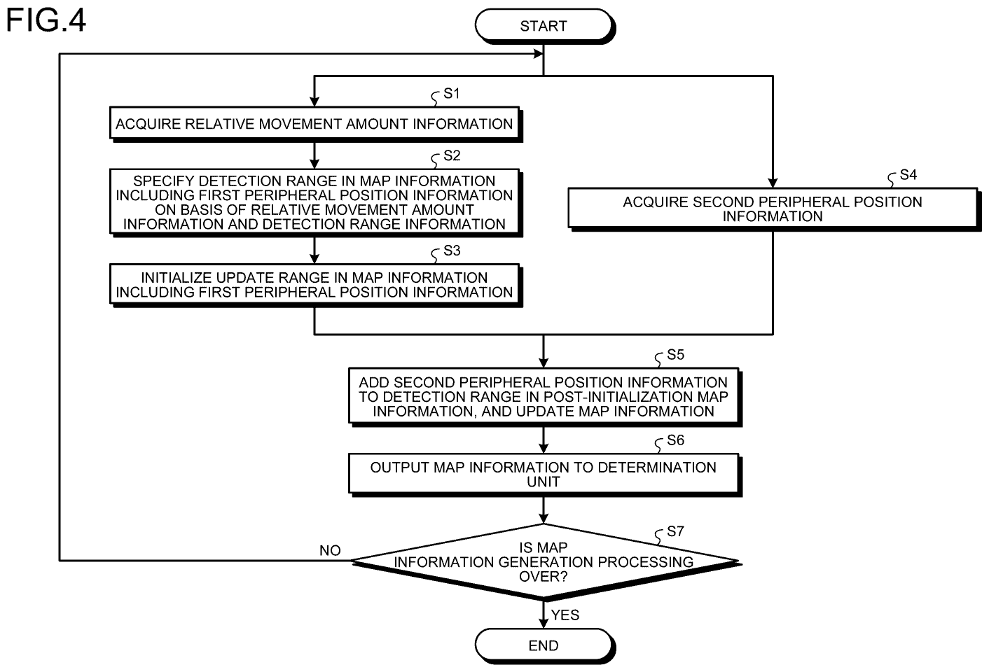

FIG. 4 is a flowchart illustrating an example of a procedure of the map information generation processing. A procedure of the map information generation processing, and the like will be described with reference to FIG. 4 to FIG. 10.

### Map Information Generation Processing

Along with the movement of the moving body 2, the acquisition unit 20 acquires the CAN data from the moving body 2. The own position estimation unit 221 estimates the own position information of the moving body 2 by the odometry method using the CAN data. The relative movement amount information is acquired by, for example, calculation of a movement vector by the odometry method based on the CAN data such as a speed and a rudder angle of the moving body 2. As described above, the relative movement amount information (movement vector) of the moving body 2 is acquired on the basis of the CAN data (Step S1).

The first offset adjustment unit 223 reads the detection range information 23A from the storage unit 231. The first offset adjustment unit 223 adjusts the first offset in the detection range on the basis of the detection range information 23A and the relative movement amount information. The initialization unit 225 specifies the detection range in the map information 23B on the basis of the adjusted first offset (first coordinate information) and the map information 23B. From the above, the detection range in the map information 23B including the first peripheral position information is specified on the basis of the relative movement amount information and the detection range information 23A (Step S2). The specified detection range is information indicating a predetermined range in the periphery of the moving body relative to the moving body 2, and corresponds to the update range to be initialized by the initialization unit 225. That is, the detection range corresponding to the update range corresponds to the information of the periphery of the moving body with reference to the position of the moving body 2 (own position information).

The initialization unit 225 initializes the information of the detection points included in the update range in the map information 23B. For example, as initialization of the information of the detection points included in the update range, the initialization unit 225 deletes the peripheral position information included in the detection range in the first peripheral position information from the map information 23B including the first peripheral position information. As a result, the map information 23B including the first peripheral position information in the update range is initialized (Step S3). That is, by the processing of Step S2 and Step S3, the peripheral position information located in the update range in the first peripheral position information already accumulated in the map information 23B is deleted by utilization of the relative movement amount information and the update range. As a result, the post-initialization map information in which the data in the update range is initialized is generated.

The acquisition unit 20 acquires the position information of the detection points (second peripheral position information) from the detection units 14 along with the movement of the moving body 2 (Step S4). In a case where the moving body 2 is stopped, the acquisition unit 20 acquires the position information of the detection points (second peripheral position information) from the detection units 14 at the time interval, for example.

The second offset adjustment unit 227 adjusts the second offset of the position of the detection points on the basis of the second peripheral position information and the relative movement amount. The addition unit 229 specifies the detection range of the detection units 14 in the post-initialization map information on the basis of the adjusted second offset (second coordinate information) and the post-initialization map information. The addition unit 229 adds the second peripheral position information to the detection range in the map information 23B. As a result, the acquired second peripheral position information is added to the map information 23B by utilization of the relative movement amount information. As described above, the map information 23B is updated (Step S5).

The addition unit 229 outputs the updated map information 23B to the determination unit 30 and the storage unit 231 (Step S6). Note that an output destination of the updated map information 23B is not limited to the above, and may be output to various components that use the updated map information 23B.

When the map information generation processing is not ended (No in Step S7), the processing in and after Step S1 is repeated. That is, when it is determined by the information processing device 10 that the map information generation processing is to be continued (No in Step S7), deletion of the peripheral position information within the update range from the map information 23B again and addition of the newly acquired peripheral position information (second peripheral position information) are repeatedly executed. When the map information generation processing is ended (Yes in Step S7), the procedure of the map information generation processing is ended. The determination of the end of the map information generation processing is, for example, a stop of the power supply in the moving body 2 (such as a stop of an operation power supply in a case where the moving body 2 is the vehicle). Note that the determination of the end of the map information generation processing is not limited to the stop of the power supply in the moving body 2, and can be arbitrarily set.

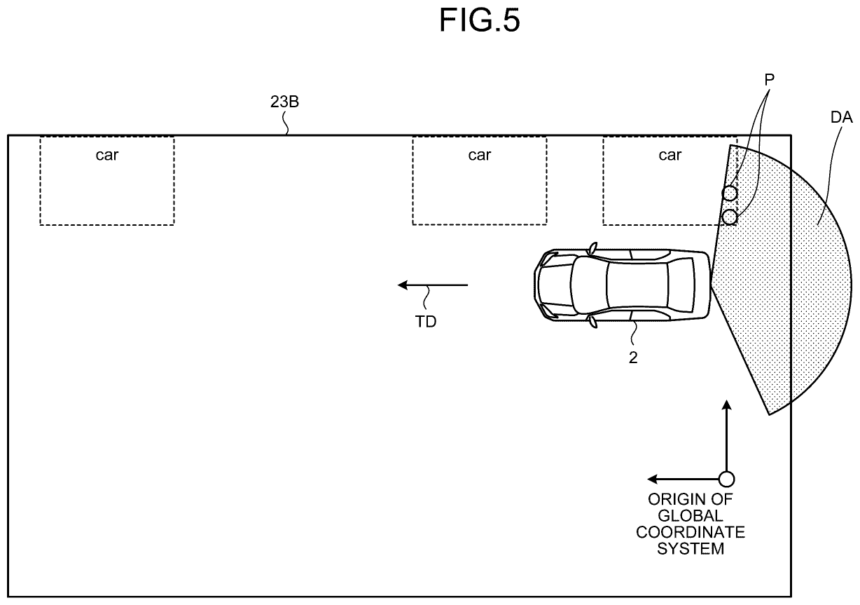

FIG. 5 is a schematic diagram illustrating an example of the map information 23B. In the map information 23B illustrated in FIG. 5, for convenience of description, the moving body 2, a traveling direction TD of the moving body 2, the detection range DA of the detection units 14, and a character string car indicating another vehicle are illustrated. As illustrated in FIG. 5, the map information 23B is information in which point cloud information that is position information of the detection points P (first peripheral position information) is registered at a corresponding coordinate position in the three-dimensional coordinate space (global coordinate system) along with the movement of the moving body 2.

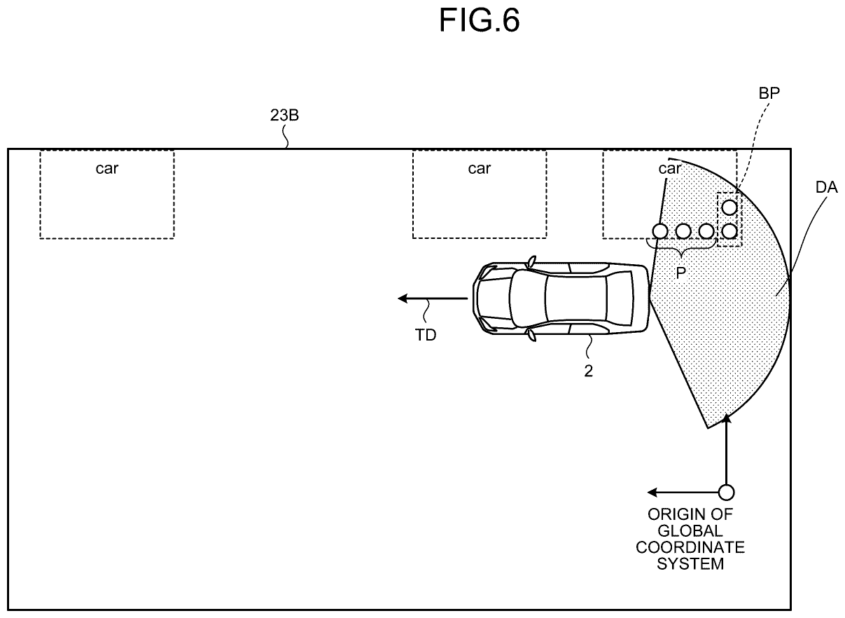

FIG. 6 is a view illustrating an example of the map information 23B of a case where the moving body 2 travels in the traveling direction TD from the position thereof illustrated in FIG. 5. In the map information 23B illustrated in FIG. 6, for convenience of description, the moving body 2, the traveling direction TD of the moving body 2, the detection range DA of the detection units 14, and the character string car indicating the other vehicle are illustrated.

In addition, as illustrated in FIG. 6, although being once deleted from the map information 23B by the initialization by the initialization unit 225, the detection points BP detected in FIG. 5 are added to the map information 23B together with other detection points (white circles illustrated in FIG. 5) by the addition unit 229. As illustrated in FIG. 6, position information of an object (car) in the periphery of the moving body 2 is acquired by the detection units 14 (plurality of sensors) installed on the rear of the moving body 2, and the acquired position information is accumulated in the map information 23B as the first peripheral position information.

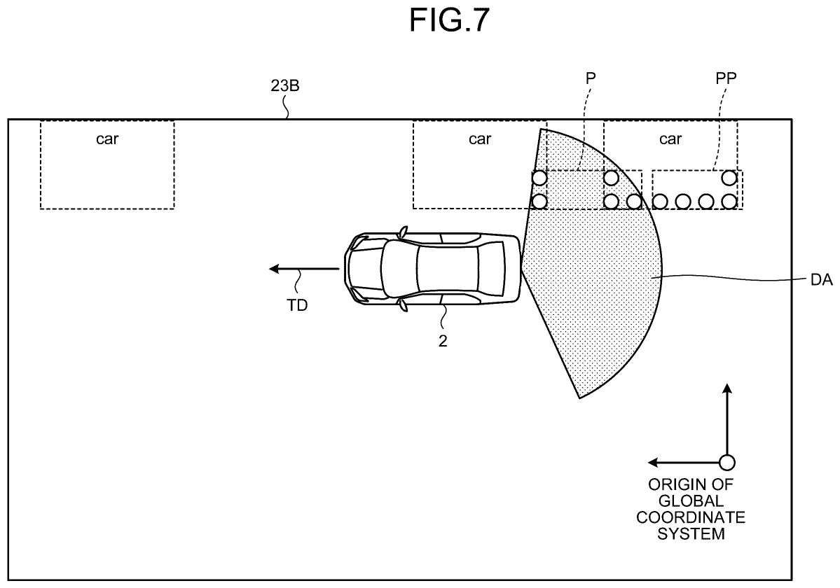

FIG. 7 is a view illustrating an example of the map information 23B of a case where the moving body 2 travels in the traveling direction TD from the position thereof illustrated in FIG. 6. In the map information 23B illustrated in FIG. 7, for convenience of description, the moving body 2, the traveling direction TD of the moving body 2, the detection range DA of the detection units 14, and the character string car indicating the other vehicle are illustrated. As illustrated in FIG. 7, even when going out of the detection range DA, the position information (detection points) PP is updated on the basis of information of the odometry method using the CAN data, and is accumulated in the map information 23B as the first peripheral position information.

In FIG. 5 to FIG. 7, although the detection units 14 (sensors) mounted on the rear of the moving body 2 are described as the example, the embodiment is not limited thereto. For example, position information of an object in the periphery of the moving body 2 may be acquired by the detection units 14 (sensors) installed on the front or on the sides of the vehicle of the moving body P at the time of forward movement of the moving body 2, or the like.

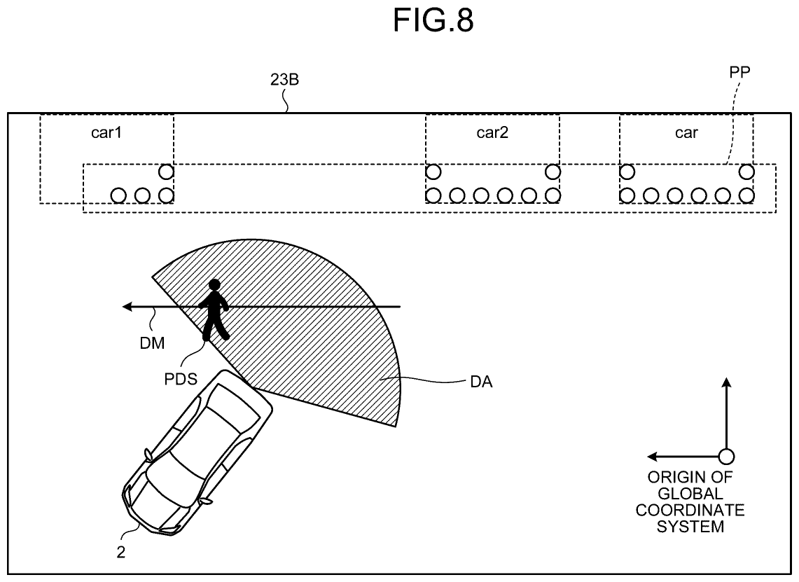

FIG. 8 is a view illustrating an example of the map information 23B of a case where the front of the moving body 2 is moved from the position of the moving body 2 illustrated in FIG. 7 to the front in the traveling direction TD, and then the moving body 2 is parked backward between two vehicles (car1 and car2). A state in which a pedestrian PDS as a moving object crosses the rear of the moving body 2 from the right to the left in the rear of the moving body 2 is illustrated in FIG. 8 for convenience of description.

That is, in the map information 23B in FIG. 8, for convenience of description, the moving body 2, the pedestrian PDS, the moving direction DM of the pedestrian PDS, the detection range DA of the detection units 14, and the character strings car (car1, car2, and car) indicating other vehicles are illustrated.

As illustrated in FIG. 8, the pedestrian PDS is moving in the moving direction DM. At this time, in a case where the map information 23B in the update range is not initialized, the detection points are accumulated along the movement of the pedestrian PDS. That is, the detection points exist at the positions passed by the pedestrian PDS, and the information of the detection points accumulated in the map information 23B is different from an actual position of the pedestrian PDS in the periphery of the moving body 2. On the other hand, in the present embodiment, since being sequentially deleted by the initialization unit 225, the detection points of the pedestrian PDS are not accumulated in the map information 23B. That is, as illustrated in FIG. 8, since the detection range DA is constantly updated to the latest state, the past detection points of the pedestrian PDS do not remain in the map information 23B. Thus, the difference between the information on the detection points accumulated in the map information 23B and the actual position of the pedestrian PDS in the periphery of the moving body 2 is controlled. Note that past detection points PP of an immovable object detected in the detection range DA are sequentially updated and accumulated by the odometry method using the CAN data, and remain in the map information 23B as the first peripheral position information. In addition, the object that is detected in the detection range DA and is to be updated to the latest state is not limited to the pedestrian PDS, and may be, for example, another moving object or a stationary object.

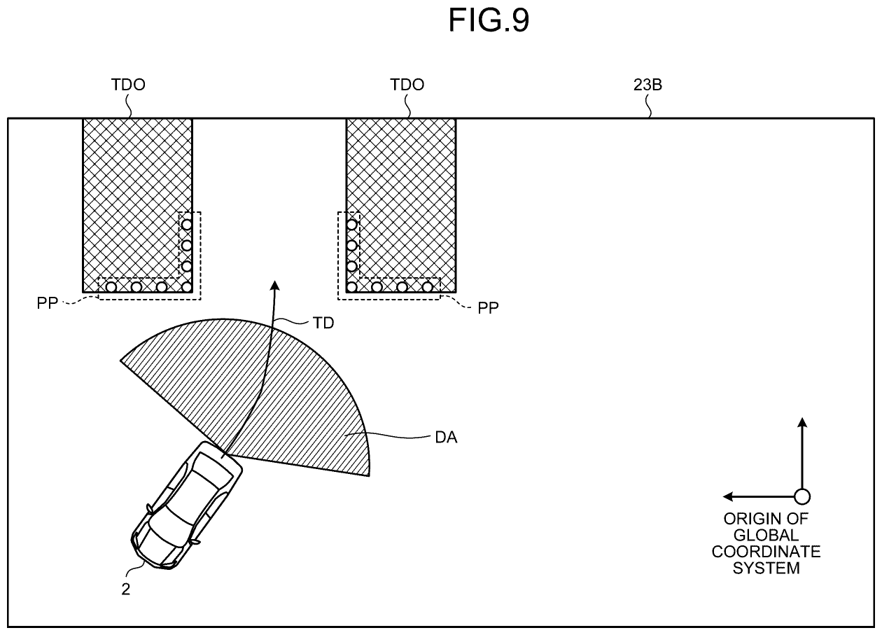

FIG. 9 is a view illustrating an example of the map information 23B in backward parking different from that in FIG. 8. In FIG. 9, for convenience of description, a three-dimensional object TDO, the moving body 2, the traveling direction (backward direction) TD of the moving body 2, and the detection range DA of the detection units 14 are illustrated. The first peripheral position information PP in FIG. 9 indicates the map information already accumulated in the map information 23B. As illustrated in FIG. 9, in the map information 23B, the first peripheral information PP is indicated by white circles.

A state in which the range in which the sensors acquire the position information of the object in the periphery of the moving body 2 coincides with the update range in which the position information is deleted is illustrated in FIG. 5 to FIG. 9. The range in which the position information is acquired and the update range do not need to strictly coincide with each other. For example, the sensors may acquire position information farther than the update range. At this time, the update range is set to be included in the range in which the position information is acquired. In addition, the update range may be set to a range farther than the acquisition range of the position information by the sensors.

In addition, although the map information 23B is updated while the information of the relative movement amount of the moving body 2 is acquired in FIG. 5 to FIG. 9, the peripheral position information may be deleted and added in a state in which the moving body 2 is stopped. In this case, for example, even in a case where the pedestrian PDS crosses behind the stopped moving body 2, it is possible to control the accumulation of the position information along a trace of the pedestrian PDS in the map information 23B.

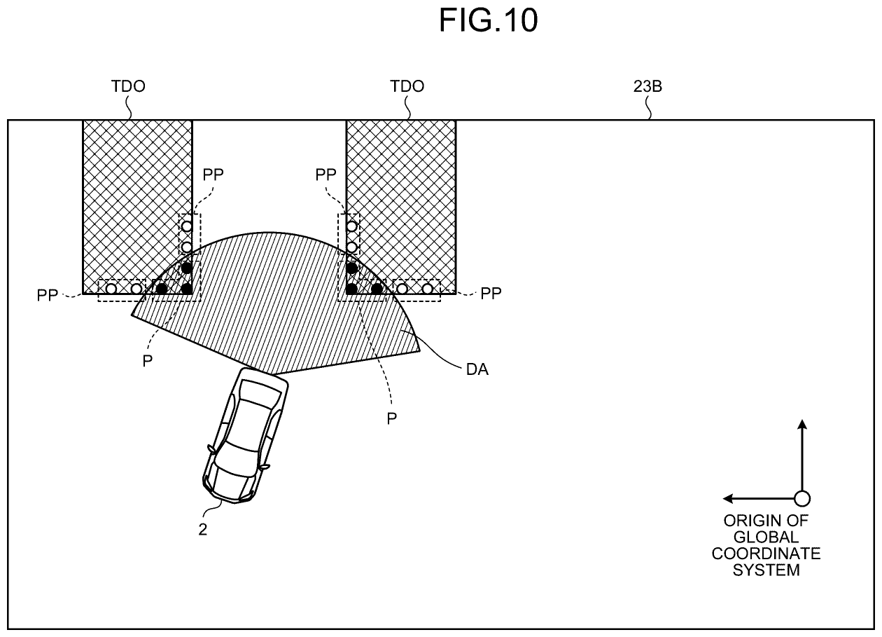

FIG. 10 is a view illustrating an example of the map information 23B in a state in which the moving body 2 further moves in the backward direction TD from the position of the moving body 2 in FIG. 9. In FIG. 10, for convenience of description, the three-dimensional object TDO, the moving body 2, the traveling direction (backward direction) TD of the moving body 2, and the detection range DA of the detection units 14 are illustrated. In the map information 23B in FIG. 10, the first peripheral position information PP is indicated by white circles, and the second peripheral position information P is indicated by black circles. The position information corresponding to the black circles illustrated in FIG. 10 is deleted from the map information 23B by the initialization unit 225 and added to the map information 23B by the addition unit 229 along with the movement of the moving body 2.

Returning to FIG. 3, the determination unit 30 will be described. The determination unit 30 determines a projection shape of a projection surface by using the map information 23B and the own position information. That is, the determination unit 30 determines the projection shape of the projection surface by using the position information of the detection points P (the first peripheral position information and the second peripheral position information) accumulated in the map information 23B and the own position information. The projection surface is a three-dimensional surface on which a peripheral image of the moving body 2 is projected.

In other words, the projection surface is a virtual three-dimensional surface on which a photographed image 50 in the periphery of the moving body is projected. The projection shape of the projection surface has a three-dimensional (3D) shape virtually formed in a virtual space corresponding to the real space. The peripheral image of the moving body 2 is the photographed image of the periphery of the moving body 2. In the present embodiment, the peripheral image of the moving body 2 is a photographed image photographed by each of the photographing units 12A to 12D.

Note that in a case where the own position information is registered in the map information 23B, the determination unit 30 determines the shape of the projection surface on the basis of the map information 23B. The determination unit 30 determines, as the projection shape, a shape acquired by deformation of a reference projection surface according to the position information of the detection points P registered in the map information 23B.

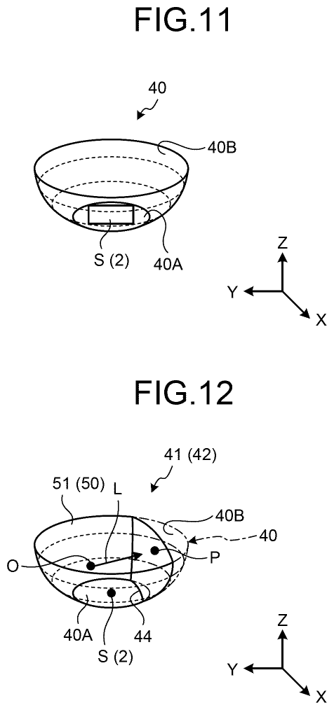

FIG. 11 is a schematic diagram illustrating an example of a reference projection surface 40. The reference projection surface 40 is, for example, a projection surface having a shape serving as a reference when the shape of the projection surface is changed. The shape of the reference projection surface 40 is, for example, a bowl shape, a cylindrical shape, or the like.

The bowl shape has a bottom surface 40A and a side wall surface 40B, and one end of the side wall surface 40B is continuous with the bottom surface 40A and the other end is opened. A width of a horizontal section of the side wall surface 40B increases from a side of the bottom surface 40A toward an opening side of the other end portion. The bottom surface 40A has, for example, a circular shape. Here, the circular shape is a shape including a perfect circular shape and a circular shape other than the perfect circular shape, such as an elliptical shape. The horizontal section is an orthogonal plane orthogonal to a vertical direction (arrow Z direction). The orthogonal plane is a two-dimensional plane in an arrow X direction orthogonal to the arrow z direction, and an arrow Y direction orthogonal to the arrow Z direction and the arrow X direction. Hereinafter, the horizontal section and the orthogonal plane may be referred to as an XY plane in the description. Note that the bottom surface 40A may have a shape other than the circular shape, such as an oval shape.

The cylindrical shape is a shape including the circular bottom surface 40A and the side wall surface 40B continuous with the bottom surface 40A. In addition, the side wall surface 40B included in the cylindrical reference projection surface 40 has a cylindrical shape in which an opening at one end portion is continuous with the bottom surface 40A and the other end portion is opened. However, the side wall surface 40B included in the cylindrical reference projection surface 40 has a shape in which a diameter of the XY plane is substantially constant from the side of the bottom surface 40A toward the opening side of the other end portion. Note that the bottom surface 40A may have a shape other than the circular shape, such as an oval shape.

In the present embodiment, a case where the shape of the reference projection surface 40 is the bowl shape will be described as an example. The reference projection surface 40 is a three-dimensional model virtually formed in a virtual space in which the bottom surface 40A is a surface substantially coinciding with a road surface below the moving body 2 and a center of the bottom surface 40A is an own position S of the moving body 2. The own position S corresponds to the own position information.

The determination unit 30 determines, as the projection shape, a shape acquired by deformation of the reference projection surface 40 into a shape passing through the detection point P closest to the moving body 2. The shape passing through the detection point P means that the side wall surface 40B after the deformation has a shape passing through the detection point P.

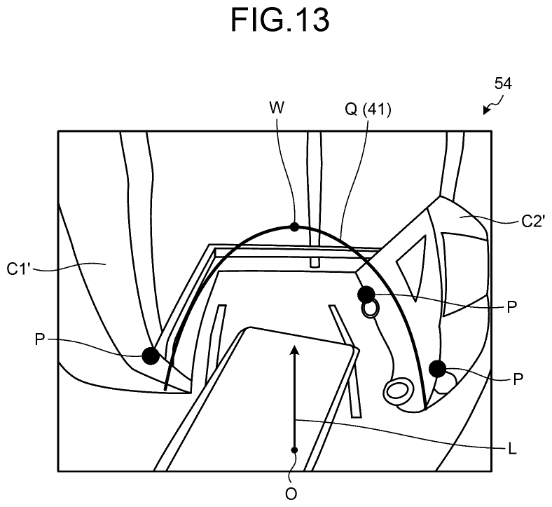

FIG. 12 is a schematic diagram illustrating an example of a projection shape 41. The determination unit 30 determines, as the projection shape 41, a shape acquired by deformation of the reference projection surface 40 into a shape passing through the detection point P closest to the own position S of the moving body 2 which position is the center of the bottom surface 40A of the reference projection surface 40. The own position S is the latest own position S calculated by the own position estimation unit 24, that is, the latest position of the moving body 2.

The determination unit 30 specifies the detection point P closest to the own position S among the plurality of detection points P registered in the map information 23B. Specifically, XY coordinates of the center position (own position S) of the moving body 2 are set as (X, Y)=(0, 0). Then, the determination unit 30 specifies the detection point P at which a value of X2+Y2 indicates the minimum value as the detection point P closest to the own position S. Then, the determination unit 30 determines, as the projection shape 41, a shape acquired by the deformation in such a manner that the side wall surface 40B of the reference projection surface 40 passes through the detection point P.

Specifically, the determination unit 30 determines a deformed shape of a part of regions of the bottom surface 40A and the side wall surface 40B as the projection shape 41 in such a manner that a part of the region of the side wall surface 40B becomes a wall surface passing through the detection point P closest to the moving body 2 when the reference projection surface 40 is deformed. The deformed projection shape 41 is, for example, a shape rising from a rising line 44 on the bottom surface 40A in a direction toward the center of the bottom surface 40A. Rising means, for example, bending or folding the part of the side wall surface 40B and the bottom surface 40A in the direction toward the center of the bottom surface 40A in such a manner that an angle formed by the side wall surface 40B and the bottom surface 40A of the reference projection surface 40 becomes a smaller angle.

The determination unit 30 determines a specific region on the reference projection surface 40 to be deformed in such a manner as to protrude to the position passing through the detection point P in a viewpoint of the XY plane (in a plan view). A shape and range of the specific region may be determined on the basis of a predetermined reference. Then, the determination unit 30 determines the shape of the reference projection surface 40 to be deformed in such a manner that a distance from the own position S is continuously increased from the protruded specific region toward a region other than the specific region on the side wall surface 40B.

Specifically, as illustrated in FIG. 12, it is preferable to determine the projection shape 41 in such a manner that an outer periphery of the cross section along the XY plane has a curved shape. Note that the shape of the outer periphery of the cross section of the projection shape 41 is, for example, a circular shape, but may be a shape other than the circular shape.

Note that the determination unit 30 may determine a shape acquired by deformation of the reference projection surface 40 in such a manner as to have a shape along an asymptotic curve as the projection shape 41. The asymptotic curve is an asymptotic curve of the plurality of detection points P. The determination unit 30 generates the asymptotic curve of a predetermined number of the plurality of detection points P in a direction away from the detection point P closest to the own position S of the moving body 2. The number of detection points P only needs to be plural. For example, the number of detection points P is preferably three or more. Furthermore, in this case, the determination unit 30 preferably generates the asymptotic curve of the plurality of detection points P at positions separated by a predetermined angle or more when viewed from the own position S.

FIG. 13 is a view for describing the asymptotic curve Q. FIG. 13 is a view illustrating an example in which the asymptotic curve Q is indicated in a projection image 51 acquired by projection of the photographed image on the projection surface in a case where the moving body 2 is viewed from above. For example, it is assumed that the determination unit 30 specifies three detection points P in order of proximity to the own position S of the moving body 2. In this case, the determination unit 30 generates the asymptotic curve Q of these three detection points P. Then, the determination unit 30 only needs to determine, as the projection shape 41, a shape acquired by deformation of the reference projection surface 40 in such a manner as to have a shape along the generated asymptotic curve Q.

Note that the determination unit 30 may divide a periphery of the own position S of the moving body 2 for each specific angular range, and may specify the detection point P closest to the moving body 2 or a plurality of the detection points P in order of proximity to the moving body 2 for each angular range. Then, the determination unit 30 may determine, as the projection shape 41, the shape acquired by the deformation of the reference projection surface 40 in such a manner as to have a shape passing through the specified detection point P or the shape along the asymptotic curve Q of the plurality of specified detection points P for each angular range.

Next, an example of a detailed configuration of the determination unit 30 will be described.

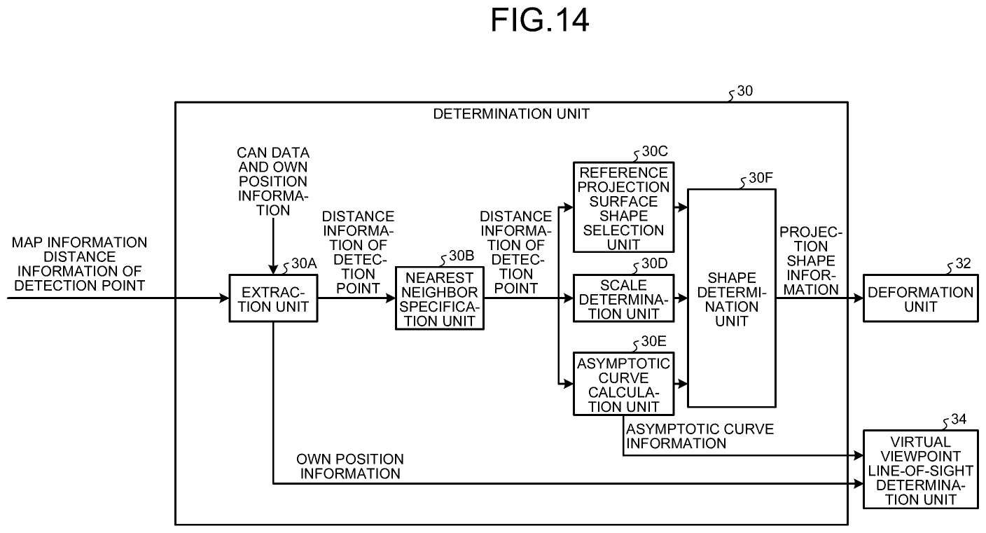

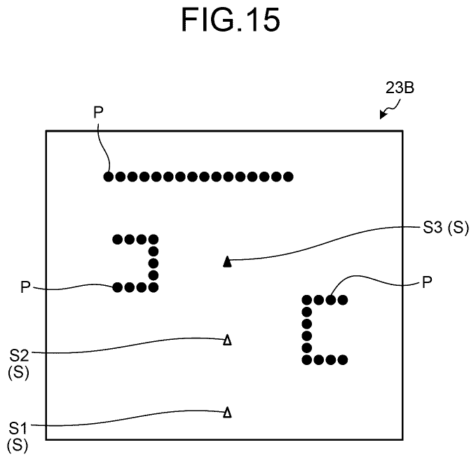

FIG. 14 is a schematic diagram illustrating an example of the configuration of the determination unit 30. The determination unit 30 includes an extraction unit 30A, a nearest neighbor specification unit 30B, a reference projection surface shape selection unit 30C, a scale determination unit 30D, an asymptotic curve calculation unit 30E, and a shape determination unit 30F.

The extraction unit 30A extracts a detection point P present within a specific range among the plurality of detection points P included in the map information 23B by using the own position information of the moving body 2 and the map information 23B. Here, the map information 23B includes information of the distance from the moving body 2 to the detection point P. The specific range is, for example, a range from the road surface on which the moving body 2 is arranged to a height corresponding to a vehicle height of the moving body 2. Note that the range is not limited to this range. When the extraction unit 30A extracts the detection point P within the range, for example, it is possible to extract a detection point P of an object that blocks traveling of the moving body 2. The extraction unit 30A outputs distance information of each extracted detection point P to the nearest neighbor specification unit 30B. The extraction unit 30A outputs the current own position information of the moving body 2 to the virtual viewpoint line-of-sight determination unit 34. Note that in a case where the distance information from the moving body 2 to the detection point P is not included in the map information 23B, the distance information may be calculated by utilization of the map information 23B and the own position information and be input to the extraction unit 30A.

The nearest neighbor specification unit 30B divides the periphery of the own position S of the moving body 2 for each specific angular range, and specifies the detection point P closest to the moving body 2 or the plurality of detection points P in order of proximity to the moving body 2 for each angular range. The nearest neighbor specification unit 30B specifies the detection point P by using the distance information received from the extraction unit 30A. In the present embodiment, a form in which the nearest neighbor specification unit 30B specifies the plurality of detection points P in order of proximity to the moving body 2 for each angular range will be described as an example.

The nearest neighbor specification unit 30B outputs the distance information of the detection points P specified for each angular range to the reference projection surface shape selection unit 30C, the scale determination unit 30D, and the asymptotic curve calculation unit 30E.

The reference projection surface shape selection unit 30C selects the shape of the reference projection surface 40. The reference projection surface shape selection unit 30C selects the shape of the reference projection surface 40 by reading one specific shape from the storage unit 231 that stores a plurality of kinds of shapes of the reference projection surface 40. For example, the reference projection surface shape selection unit 30C selects the shape of the reference projection surface 40 according to a positional relationship, distance information, and the like between the own position and a peripheral three-dimensional object. Note that the shape of the reference projection surface 40 may be selected by an operation instruction from the user. The reference projection surface shape selection unit 30C outputs shape information of the determined reference projection surface 40 to the shape determination unit 30F. In the present embodiment, as described above, a form in which the reference projection surface shape selection unit 30C selects a bowl-shaped reference projection surface 40 will be described as an example.

The scale determination unit 30D determines a scale of the reference projection surface 40 having the shape selected by the reference projection surface shape selection unit 30C. For example, in a case where there is the plurality of detection points P in a range of a predetermined distance from the own position S, the scale determination unit 30D makes determination to reduce the scale, or the like. The scale determination unit 30D outputs scale information of the determined scale to the shape determination unit 30F.

The asymptotic curve calculation unit 30E outputs the asymptotic curve information of the calculated asymptotic curve Q to the shape determination unit 30F and the virtual viewpoint line-of-sight determination unit 34 by using the distance information of the detection point P closest to the own position S for each angular range from the own position S which distance information is received from the nearest neighbor specification unit 30B. Note that the asymptotic curve calculation unit 30E may calculate the asymptotic curve Q of the detection points P accumulated for each of a plurality of portions of the reference projection surface 40. Then, the asymptotic curve calculation unit 30E may output the asymptotic curve information of the calculated asymptotic curve Q to the shape determination unit 30F and the virtual viewpoint line-of-sight determination unit 34.

The shape determination unit 30F enlarges or reduces the reference projection surface 40 having the shape indicated by the shape information received from the reference projection surface shape selection unit 300 to the scale of the scale information received from the scale determination unit 30D. Then, the shape determination unit 30F determines, as the projection shape 41, a shape acquired by deformation of the enlarged or reduced reference projection surface 40 in such a manner as to have a shape along the asymptotic curve information of the asymptotic curve Q which information is received from the asymptotic curve calculation unit 30E. The shape determination unit 30F outputs projection shape information of the determined projection shape 41 to the deformation unit 32.

Returning to FIG. 3, the description will be continued. Next, the deformation unit 32 will be described. The deformation unit 32 deforms the reference projection surface 40 into the projection shape 41 indicated by the projection shape information received from the determination unit 30. That is, on the basis of the map information 23B, the deformation unit 32 deforms the projection surface on which the photographed image of the periphery of the moving body is projected. Specifically, the deformation unit 32 deforms the projection surface on the basis of the first peripheral position information and the second peripheral position information that are not initialized in the map information 23B.

Through the deformation processing, the deformation unit 32 generates a deformed projection surface 42 that is the deformed reference projection surface 40 (see FIG. 12). That is, the deformation unit 32 deforms the reference projection surface 40 by using the position information of the detection points P accumulated in the map information 23B and the own position information of the moving body 2. Specifically, for example, the deformation unit 32 deforms the reference projection surface 40 into a curved surface shape passing through the detection point P closest to the moving body 2 on the basis of the projection shape information. Through this deformation processing, the deformation unit 32 generates the deformed projection surface 42.

For example, on the basis of the projection shape information, the deformation unit 32 deforms the reference projection surface 40 into a shape along an asymptotic curve Q of a predetermined number of the detection points P in order of proximity to the moving body 2. Note that the deformation unit 32 preferably deforms the reference projection surface 40 by using the position information of the detection points P acquired before the first time and the own position information of the own position S.

Here, the first time is the latest time at which the position information of the detection points P is detected by the detection units 14, or arbitrary time earlier than the latest time. For example, the detection points P acquired before the first time include position information of a specific object in the periphery of the moving body 2, and the detection points P acquired at the first time does not include the position information of the specific object in the periphery. The determination unit 30 may determine the projection shape 41 in a manner similar to the above by using the position information of the detection points P acquired before the first time and included in the map information 23B. Then, the deformation unit 32 may generate the deformed projection surface 42 in a manner similar to the above by using projection shape information of the projection shape 41.

In this case, for example, even in a case where the position information of the detection point P detected by the detection units 14 at the first time does not include the position information of the detection point P detected earlier than the time, the deformation unit 32 can generate the deformed projection surface 42 corresponding to the detection point P detected in the past.

Next, the projection conversion unit 36 will be described. The projection conversion unit 36 generates the projection image 51 acquired by projection of the photographed image, which is acquired from the photographing units 12, on the deformed projection surface 42 that is the reference projection surface 40 deformed by the deformation unit 32. Specifically, the projection conversion unit 36 receives deformed projection surface information of the deformed projection surface 42 from the deformation unit 32. The deformed projection surface information is information indicating the deformed projection surface 42. The projection conversion unit 36 projects the photographed image acquired from the photographing units 12 via the acquisition unit 20 onto the deformed projection surface 42 indicated by the received deformed projection surface information. Through this projection processing, the projection conversion unit 36 generates the projection image 51. The projection conversion unit 36 converts the projection image 51 into a virtual viewpoint image. The virtual viewpoint image is an image in which the projection image 51 is visually recognized in an arbitrary direction from a virtual viewpoint.

The projection conversion unit 36 will be described with reference to FIG. 12. The projection conversion unit 36 projects the photographed image 50 onto the deformed projection surface 42. Then, the projection conversion unit 36 generates a virtual viewpoint image that is an image acquired by visual recognition of the photographed image 50, which is projected on the deformed projection surface 42, in a line-of-sight direction L from an arbitrary virtual viewpoint O (not illustrated). A position of the virtual viewpoint O may be, for example, the latest own position S of the moving body 2. In this case, values of XY coordinates of the virtual viewpoint O may be set as values of the XY coordinates of the latest own position S of the moving body 2. Furthermore, a value of a Z coordinate (position in the vertical direction) of the virtual viewpoint O may be set as a value of a Z coordinate of the detection point P closest to the own position S of the moving body 2. The line-of-sight direction L may be determined on the basis of a predetermined reference, for example.

The line-of-sight direction L may be, for example, a direction from the virtual viewpoint O toward the detection point P closest to the own position S of the moving body 2. In addition, the line-of-sight direction L may be a direction that passes through the detection point P and is perpendicular to the deformed projection surface 42. Virtual viewpoint line-of-sight information indicating the virtual viewpoint O and the line-of-sight direction L is created by the virtual viewpoint line-of-sight determination unit 34.

Returning to FIG. 3, the description will be continued. The virtual viewpoint line-of-sight determination unit 34 determines the virtual viewpoint line-of-sight information in the following procedure, for example. The virtual viewpoint line-of-sight determination unit 34 determines, as the line-of-sight direction L, a direction that passes through the detection point P closest to the own position S of the moving body 2 and that is perpendicular to the deformed projection surface 42. Note that the virtual viewpoint line-of-sight determination unit 34 may fix a direction of the line-of-sight direction L and determine the coordinates of the virtual viewpoint O as an arbitrary Z coordinate and arbitrary XY coordinates in a direction away from the asymptotic curve Q toward the own position S. In this case, the XY coordinates may be coordinates at a position farther from the asymptotic curve

Q than the own position S. Then, the virtual viewpoint line-of-sight determination unit 34 outputs the virtual viewpoint line-of-sight information indicating the virtual viewpoint O and the line-of-sight direction L to the projection conversion unit 36. Note that as illustrated in FIG. 13, the line-of-sight direction L may be a direction from the virtual viewpoint O toward a position of a vertex W of the asymptotic curve Q.

The projection conversion unit 36 receives the virtual viewpoint line-of-sight information from the virtual viewpoint line-of-sight determination unit 34. The projection conversion unit 36 receives the virtual viewpoint line-of-sight information and specifies the virtual viewpoint O and the line-of-sight direction L. Then, the projection conversion unit 36 generates the virtual viewpoint image, which is the image visually recognized from the virtual viewpoint O in the line-of-sight direction L, from the photographed image 50 projected on the deformed projection surface 42. The virtual viewpoint image corresponds to, for example, an image in which the photographed image 50 can be visually recognized from the virtual viewpoint O in the line-of-sight direction L. The projection conversion unit 36 outputs the virtual viewpoint image to the image composition unit 38.

The image composition unit 38 generates a composite image acquired by extraction of a part or whole of the virtual viewpoint image. For example, the image composition unit 38 performs determination of a width of an overlapping portion of a plurality of the photographed images 50 included in the virtual viewpoint image, lamination processing of the photographed images 50, and blending processing of determining the photographed image 50 to be displayed in the overlapping portion. As a result, a composite image 54 is generated. Then, the image composition unit 38 outputs the composite image 54 to the display unit 16. Note that the composite image 54 may be a bird's-eye view image in which an upper side of the moving body 2 is the virtual viewpoint O, or may display the moving body 2 translucently with the inside of the moving body 2 as the virtual viewpoint O.

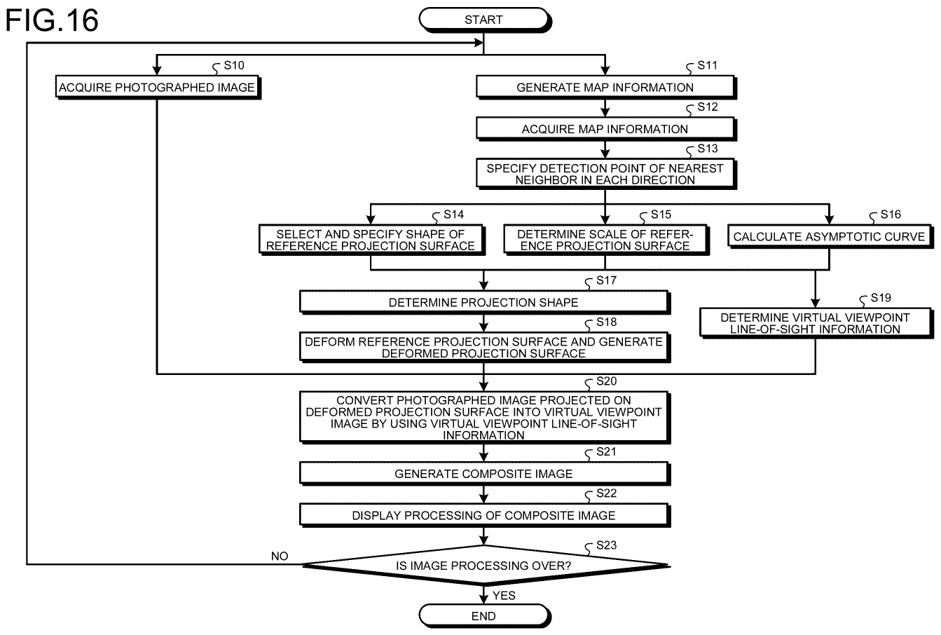

Next, an example of a flow of image processing executed by the information processing device 10 will be described. FIG. 16 is a flowchart illustrating an example of a procedure of the image processing executed by the information processing device 10.

### Image Processing

The acquisition unit 20 acquires the photographed image 50 from the photographing units 12 (Step S10). The acquisition unit 20 outputs the acquired photographed image 50 to the projection conversion unit 36.

The acquisition unit 20 acquires the position information of each of the plurality of detection points P from the detection units 14. In addition, the acquisition unit 20 acquires the CAN data from the ECU 3. The map information 23B is generated by the above-described map information generation processing based on the position information of each of the plurality of detection points P and the CAN data (Step S11).

The determination unit 30 acquires the generated map information 23B (Step S12).

The extraction unit 30A extracts a detection point P present within a specific range among the detection points P. The nearest neighbor specification unit 30B specifies the plurality of detection points P in order of proximity to the moving body 2 for each angular range (direction) around the moving body 2 by using distance information of each of the extracted detection points P. As a result, the detection point closest to the moving body 2 is specified for each direction in the specific range (Step S13).

The reference projection surface shape selection unit 30C selects the shape of the reference projection surface 40 (Step S14). As described above, a form in which the reference projection surface shape selection unit 30C selects a bowl-shaped reference projection surface 40 will be described as an example. Note that the shape of the reference projection surface 40 to be used for the image processing may be selected from among the plurality of kinds of shapes of the reference projection surface 40 on the basis of the own position information of the moving body 2, the position information (first peripheral position information and/or second peripheral position information) of the object in the periphery of the moving body 2, the distance information, and the like.

The scale determination unit 30D determines the scale of the reference projection surface 40 having the shape selected in Step S14 (Step S15).

The asymptotic curve calculation unit 30E calculates the asymptotic curve Q by using each piece of the distance information of the plurality of detection points P for each angular range which detection points are specified in Step S13 (Step S16).

The shape determination unit 30F enlarges or reduces the reference projection surface 40 having the shape selected in Step S14 to the scale determined in Step S15. Then, the shape determination unit 30F deforms the enlarged or reduced reference projection surface 40 in such a manner as to have a shape along the asymptotic curve Q calculated in Step S16. The shape determination unit 30F determines the deformed shape as the projection shape 41 (Step S17).

The deformation unit 32 deforms the reference projection surface 40 selected by the reference projection surface shape selection unit 30C to the projection shape 41 determined by the determination unit 30 (Step S18). Through the deformation processing, the deformation unit 32 generates the deformed projection surface 42 that is the deformed reference projection surface 40 (see FIG. 12).

The virtual viewpoint line-of-sight determination unit 34 determines the virtual viewpoint line-of-sight information (Step S19). For example, the virtual viewpoint line-of-sight determination unit 34 determines the own position S of the moving body 2 as the virtual viewpoint O, and determines the direction from the virtual viewpoint O toward the position of the vertex W of the asymptotic curve Q as the line-of-sight direction L. Specifically, the virtual viewpoint line-of-sight determination unit 34 determines, as the line-of-sight direction L, a direction toward the vertex W of the asymptotic curve Q in one specific angular range in the asymptotic curve Q calculated for each of the angular ranges in Step S16.

The projection conversion unit 36 projects the photographed image 50 acquired in Step S10 onto the deformed projection surface 42 generated in Step $17. Then, the projection conversion unit 36 converts the projection image 51 into the virtual viewpoint image by projecting the photographed image 50 onto the deformed projection surface 42 in the line-of-sight direction L from the virtual viewpoint O determined in Step S19. That is, the projection conversion unit 36 uses the virtual viewpoint line-of-sight information and converts the photographed image 50 projected on the deformed projection surface 42 into the virtual viewpoint image (Step S20).

The image composition unit 38 generates the composite image 54 acquired by extraction of a part or whole of the virtual viewpoint image generated in Step S20 (Step S21). The virtual viewpoint image includes a portion where a plurality of the photographed images 50 overlaps (hereinafter, referred to as an overlapping portion). The image composition unit 38 performs, for example, the determination of the width of the overlapping portion, the lamination processing of the photographed images 50, the blending processing of determining the photographed image 50 to be displayed in the overlapping portion, and the like.

The image composition unit 38 executes display control to output the generated composite image 54 to the display unit 16 (Step S22). As a result, the generated composite image 54 is displayed on the display unit 16.

Then, the information processing device 10 determines whether to end the image processing (Step S23). For example, the information processing device 10 determines whether a signal indicating a stop of the operation of the moving body 2 (such as a stop of an engine) is received from the ECU 3, and makes the determination in Step S23. Furthermore, for example, the information processing device 10 may perform the determination in Step S23 by determining whether an instruction to end the image processing is received by an operation instruction or the like from the user.

When a negative determination is made in Step S23 (Step S23: No), the processing in Step S10 to Step S22 described above is repeated. When an affirmative determination is made in Step S23 (Step S23: Yes), the routine of the present image processing ends.

As described above, the information processing device 10 according to the embodiment includes the map information generation unit 22 that initializes the range (detection range) related to detection by the sensors (detection units 14) mounted on the moving body 2 in the map information 23B including the first peripheral position information that is information of the position of the object located in the periphery of the moving body, and that adds the second peripheral position information acquired from the sensors to the detection range. For example, as the initialization of data in the detection range DA, the map information generation unit 22 deletes the peripheral position information included in the detection range in the first peripheral position information from the map information 23B.

As a result, according to the information processing device 10 according to the embodiment, the peripheral position information included in the detection range in the map information 23B can be updated according to acquisition of the position information. That is, according to the information processing device 10 according to the embodiment, deletion and addition of the peripheral position information are sequentially performed in the periphery of the moving body 2 (vehicle) in the map information 23B, and the map information 23B reflecting the latest condition in the periphery of the moving body can be generated. In other words, according to the information processing device 10 according to the embodiment, the position information within the update range in the map information 23B can be constantly maintained in the latest condition.

Thus, according to the information processing device 10 according to the embodiment, as illustrated in FIG. 8, even when a moving object such as the pedestrian PDS passes through the detection range, accumulation of position information along a trace of the moving object (such as the pedestrian) in the vicinity of the moving body in the map information 23B can be controlled. From these, according to the information processing device 10 according to the embodiment, it is possible to generate the map information 23B with high accuracy (accuracy).

Furthermore, the information processing device 10 according to the embodiment further includes the deformation unit 32 that deforms the projection surface (selected reference projection surface 40), on which the photographed image 50 in the periphery of the moving body is projected, on the basis of the map information 23B generated by the map information generation processing. For example, the information processing device 10 according to the embodiment deforms the projection surface on the basis of the first peripheral position information and the second peripheral position information that are not initialized in the map information 23B. For example, as illustrated in FIG. 10, the first peripheral position information (white circles) PP and the second peripheral position information (black circles) P are used as the peripheral position information used in the deformation processing of the projection surface.

As a result, according to the information processing device 10 according to the embodiment, since the projection surface can be deformed by utilization of the accurate (accurate) map information 23B, it is possible to project the photographed image 50 on the appropriately-deformed projection surface and to present the composite image (bird's-eye view image) to the user. From these, according to the information processing device 10 according to the embodiment, it is possible to present a natural bird's-eye view image with improved visibility to the user.

Furthermore, a plurality of sensors related to the information processing device 10 according to the embodiment is mounted on the moving body 2. For example, the plurality of sensors related to the information processing device 10 according to the embodiment is arranged in an array on the exterior of the moving body 2. Furthermore, the sensors related to the information processing device 10 according to the embodiment may be distance sensors mounted on the rear of the moving body 2, and the first peripheral position information may be acquired from the distance sensors. Furthermore, the sensors related to the information processing device 10 according to the embodiment may be further arranged on the side of the moving body 2 as the distance sensors. Furthermore, in a case where the detection units 14 are realized by the plurality of sensors, peripheral position information acquired from some (nearby) sensors may be accumulated/deleted, and peripheral position information acquired by the other (distant) sensors may be used only for the accumulation. From the above, according to the information processing device 10 according to the embodiment, it is possible to generate the map information 23B with high accuracy in an arbitrary direction in the periphery of the moving body 2.

Furthermore, in the information processing device 10 according to the embodiment, the detection range corresponding to the update range corresponds to information in the periphery of the moving body with reference to the position of the moving body 2 (own position information). Furthermore, according to the information processing device 10 according to the embodiment, the peripheral position information to be deleted is determined on the basis of the information of the detection range and the information of the relative movement amount (movement vector) (relative movement amount information) of the moving body 2 with respect to the origin in the map information 23B. From these, according to the information processing device 10 according to the embodiment, it is possible to determine the peripheral position information to be deleted or the update range with reference to the moving body 2 regardless of presence or absence of the movement of the moving body 2. Thus, according to the information processing device 10 according to the embodiment, the peripheral position information included in the update range can be constantly maintained in the latest state regardless of the movement and stop of the moving body 2.

In the present embodiment, as an example of utilization of the map information 23B generated by the map information generation processing, the deformation processing of the projection surface in the backward parking has been described. However, the utilization of the map information 23B is not limited to the deformation processing of the projection surface. For example, in a case where the moving body 2 is a vehicle, the map information 23B may be used for automatic driving, forward parking, or the like.

In a case where a technical idea in the embodiment is realized by an information processing method, the information processing method initializes a range related to detection by sensors mounted on a moving body 2 in map information 23B including first peripheral position information that is information of a position of an object located in a periphery of the moving body, and adds second peripheral position information acquired from the sensors to the range. Since a procedure, an effect, and the like of map information generation processing executed by the information processing method are similar to those of the embodiment, description thereof is omitted.

In a case where a technical idea in the present embodiment is realized by an information processing program, the information processing program causes a computer to execute initialization of a range related to detection by sensors mounted on a moving body 2 in map information 23B including first peripheral position information that is information of a position of an object located in a periphery of the mobile body, and addition of second peripheral position information acquired from the sensors to the range. For example, map information generation processing can also be realized by installation of the information processing program from a nonvolatile storage medium into various server devices (processing devices) and development thereof on a memory. At this time, the program that can cause the computer to execute the technique can be distributed by being stored in a storage medium such as a magnetic disk (such as a hard disk), an optical disk (such as a CD-ROM or DVD), or a semiconductor memory. Since a processing procedure, an effect, and the like in the information processing program are similar to those in the embodiment, description thereof will be omitted.

According to such a configuration, it is possible to generate the accurate map information 23B by sequentially updating the position information within the update range. As a result, according to one aspect of the information processing device disclosed in the present application, for example, the shape of the projection surface can be appropriately deformed by utilization of the accurate map information 23B.

Although the embodiments and modification examples have been described above, the information processing device 10, the information processing method, and the information processing program disclosed in the present application are not limited to the above-described embodiments and the like as they are, and the components can be modified and embodied in each implementation stage and the like without departing from the gist thereof. In addition, various inventions can be formed by an appropriate combination of the plurality of components disclosed in the above embodiments and modification examples. For example, some components may be deleted from all the components described in the embodiments.

### EXPLANATIONS OF LETTERS OR NUMERALS

1 INFORMATION PROCESSING SYSTEM
10 INFORMATION PROCESSING DEVICE
12, 12A to 12D PHOTOGRAPHING UNIT
14, 14A to 14D DETECTION UNIT
20 ACQUISITION UNIT
22 MAP INFORMATION GENERATION UNIT
23A DETECTION RANGE INFORMATION
23B MAP INFORMATION
30 DETERMINATION UNIT
30A EXTRACTION UNIT
30B NEAREST NEIGHBOR SPECIFICATION UNIT
30C REFERENCE PROJECTION SURFACE SHAPE SELECTION UNIT
30D SCALE DETERMINATION UNIT
30E ASYMPTOTIC CURVE CALCULATION UNIT
30F SHAPE DETERMINATION UNIT
32 DEFORMATION UNIT
34 VIRTUAL VIEWPOINT LINE-OF-SIGHT DETERMINATION UNIT
36 PROJECTION CONVERSION UNIT
38 IMAGE COMPOSITION UNIT
221 OWN POSITION ESTIMATION UNIT
223 FIRST OFFSET ADJUSTMENT UNIT
225 INITIALIZATION UNIT
227 SECOND OFFSET ADJUSTMENT UNIT
229 ADDITION UNIT
231 STORAGE UNIT
233 CORRECTION UNIT

1. An information processing device comprising
a map information generation unit that initializes a range related to detection by a sensor mounted on a moving body in map information including first peripheral position information that is information of a position of an object located in a periphery of the moving body, and adds second peripheral position information acquired from the sensor to the range.

2. The information processing device according to claim 1, wherein
the map information generation unit deletes, as initialization of the range, peripheral position information included in the range in the first peripheral position information from the map information.

3. The information processing device according to claim 1, further comprising
a deformation unit that deforms, based on the map information, a projection surface on which a photographed image of the periphery of the moving body is projected.

4. The information processing device according to claim 3, wherein
the deformation unit deforms the projection surface based on the first peripheral position information and the second peripheral position information that are not initialized in the map information.

5. The information processing device according to claim 1, wherein
the sensor includes a plurality of sensors mounted on the moving body.

6. The information processing device according to claim 5, wherein
the plurality of sensors are arranged in an array on an exterior of the moving body.

7. The information processing device according to claim 1, wherein
the sensor is a distance sensor mounted on a rear of the moving body, and
the first peripheral position information is acquired from the distance sensor.

8. The information processing device according to claim 7, wherein
the sensor is further arranged on a side of the moving body as the distance sensor.

9. The information processing device according to claim 1, wherein
the range corresponds to information of the periphery of the moving body with reference to a position of the moving body.

10. The information processing device according to claim 9, wherein
the map information generation unit determines peripheral position information to be deleted as initialization, based on information of the range and information of a relative movement amount of the moving body with respect to an origin in the map information.

11. An information processing method comprising:
in map information including first peripheral position information that is information of a position of an object located in a periphery of a moving body,
initializing a range related to detection by a sensor mounted on the moving body; and
adding second peripheral position information acquired from the sensor to the range.

12. A non-transitory computer-readable medium on which programmed instructions are stored, wherein the programmed instructions, when executed by a computer,
cause the computer to execute
initializing a range related to detection by a sensor mounted on a moving body in map information including first peripheral position information that is information of a position of an object located in a periphery of the moving body; and
adding second peripheral position information acquired from the sensor to the range.
